(19) United States
(12) Patent Application Publication
(10) Pub. No.: US 2003/0018574 A1
(43) Pub. Date: Jan. 23, 2003

(54) Debt collection method

(76) Inventor: Jeff A. Shumway, Scottsdale, AZ (US)

Correspondence Address: WEISS & MOY PC, 4204 NORTH BROWN AVENUE, SCOTTSDALE, AZ, 85251, US

(21) Appl. No.: 09/910,640

(22) Filed: Jul. 20, 2001

(51) Int. Cl. G06F 17/60

(52) U.S. Cl. 705/38; 705/40

(57) ABSTRACT

A method for collecting debt in which a creditor contracts with a debt collector to take steps to collect a debt in exchange for payment of a fixed fee that is not dependent on the debt collector's success or failure in collecting the debt, or on the amount of work performed by the debt collector in attempting to collect the debt. In the preferred embodiment, the steps that the debt collector agrees to perform for the fixed fee include the sending of a demand letter, the filing of a lawsuit, the conduct of pre-trial activities in support of the lawsuit, and the trial of the lawsuit.

### BACKGROUND OF THE INVENTION

1. Field of Invention

This invention relates generally to methods for the collection of debt and, more particularly, to a method for efficiently and economically collecting debt by assertion of a creditor's rights by a service provider in return for a fixed fee.

2. Background of the Invention

The collection of debt is a problem that plagues virtually any business (and government agency) that operates on other than a pure cash basis for all of its transactions. A creditor will typically, in the first instance, attempt to collect debts by itself—by sending invoices, other notices, making phone calls, etc. However, with respect to certain debts, it often becomes clear that payment will not be forthcoming despite the creditor's efforts. For such debts, the creditor can either write the debt off or retain someone—typically either a lawyer or a collection agency—to try to collect the debt.

There are several drawbacks associated with the resort to third party debt collectors, under the current system. The typical debt collector (whether a lawyer or a collection agency) works on a percentage basis. Under this approach, the collector takes a percentage of the collected debt, typically in the range of 25% to 40% of the amount collected, and sometimes as much as 50%. Often, the collector also requires reimbursement of its costs incurred in the collection process, which can drive the collector's “take” of the amount collected over 50%. The loss of such a significant percentage of the collected debt to the collector makes the percentage not fully satisfactory to the creditor, and can result in a windfall to the collector in situations where the debt is paid after only minimal effort.

An additional drawback to the percentage approach is that, because the collector is paid on a percentage basis regardless of the amount of work performed, collectors have a disincentive to invest significant resources in any particular collection. As a result, collectors prefer relatively easy collections requiring only minimal effort and thus resulting in a more significant return on the collector's investment of time and effort. Sophisticated debtors know this, and realize that they can effectively put off a collector simply by ignoring the collector's efforts or by otherwise making himself or herself a difficult collection.

Collection can also be undertaken, typically by lawyers, with the lawyer being paid for his or her work on a per hour basis. In this situation, payment of the collector's fees is made regardless of whether the collector succeeds in making the collection. While on the one hand the fees may end up, in a particular case, constituting a smaller percentage of the recovery than a contingent fee, for smaller collection matters, an hourly-fee will generally not be economically viable, since the fee can quickly exceed the amount of the debt to be collected. Still further, the creditor cannot know at the beginning of the matter how much the total of the hourly-fees will be for the particular matter, making it difficult to budget for this type of expense. For these reasons, an hourly-fee based approach is generally unattractive to creditors looking to collect on smaller debts.

In light of these problems, it is perhaps not surprising that prior art collection practices is that they are extremely ineffective. For example, in 1999, $284 billion was put out by U.S. creditors for collection. Of this, only 13.8% was successfully collected.

A need therefore existed for a method for collecting debt that addresses the drawbacks with prior art systems and methods. The improved method should provide efficient debt collection, and should provide a success rate greater than prior art systems and methods. It should do so on a fee basis that is predictable and thus budgetable. The method should provide the creditor with an assurance that proper efforts will be made to collect the debt. The method should have sufficient teeth, so that a sophisticated debtor will not be able to defeat the collector's efforts simply by putting the collector off.

The present invention satisfies these needs and provides other, related, advantages.

### SUMMARY OF THE INVENTION

It is an object of the present invention to provide a method for collecting debt that provides efficient debt collection, at a success rate greater than prior art systems and methods.

It is a further object of the present invention to provide a method for collecting debt on a fee basis that, from the creditor's point of view, is predictable and budgetable.

It is a still further object of the present invention to provide a method for collecting debt that provides the creditor with a guarantee of specific efforts that will be made to collect the debt.

It is a yet further object of the present invention to provide a method for collecting debt that will be able to overcome a debtor's delaying tactics.

### BRIEF DESCRIPTION OF THE PREFERRED EMBODIMENTS

In accordance with one embodiment of the present invention, a method for collecting a debt is disclosed. The method comprises the steps of: retaining a collection service to collect a debt owed by a debtor to a creditor; the collection service agreeing to take steps to attempt to collect the debt from the debtor in exchange for a fixed fee payment from the creditor; wherein payment of the fixed fee payment is independent of whether the collection service is successful in collecting the debt from the debtor; and the collection service attempting to collect the debt from the debtor.

In accordance with another embodiment of the present invention, a method for collecting a debt is disclosed. The method comprises the steps of: retaining a collection service to collect a debt owed by a debtor to a creditor; the collection service agreeing to take steps to attempt to collect the debt from the debtor in exchange for a fixed fee payment from the creditor; wherein the steps include each of the sending of a demand letter to the debtor, the filing of a lawsuit against the debtor to collect the debt, the conduct of pre-trial activities in support of the lawsuit, and the conduct of a trial in support of the lawsuit; wherein payment of the fixed fee payment is independent of whether the collection service is successful in collecting the debt from the debtor; and the collection service attempting to collect the debt from the debtor by taking at least one of the steps.

### BRIEF DESCRIPTION OF THE DRAWINGS

FIG. 1 is a flow chart illustrating the different pathways that a collection can take according to the method of the present invention.

FIG. 2 is a diagram showing the primary actors in the debt collection method of the present invention.

FIG. 3 is an example of the text of a typical demand letter to a corporate entity, utilized by a debt collector practicing the method of the present invention.

FIG. 4 is an example of the text of a typical demand letter to an individual, utilized by a debt collector practicing the method of the present invention.

### DETAILED DESCRIPTION OF THE PREFERRED EMBODIMENTS

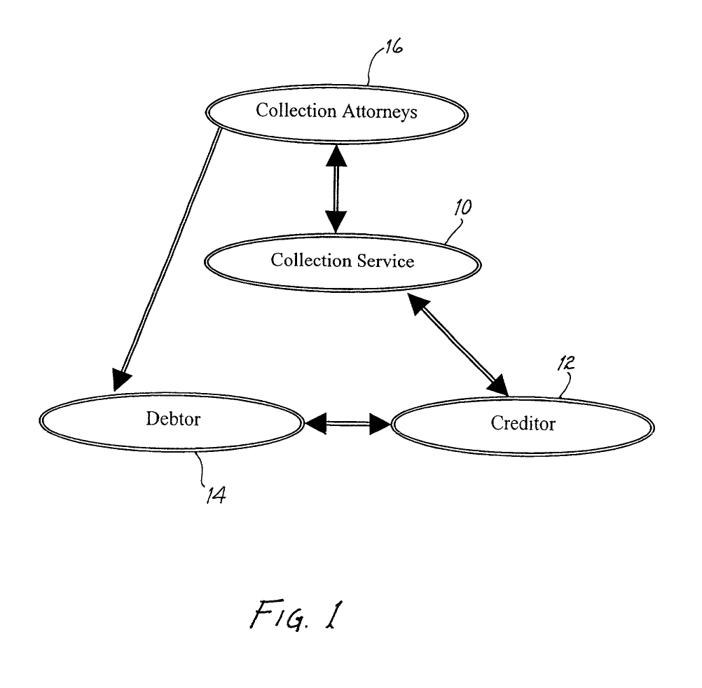

Referring first to FIG. 1, the main actors in the collection method of the present invention, and their interaction with one another, are shown. The centerpiece of the method of the present invention is the debt collector 10. The debt collector 10 contracts with creditors 12 for the collection of debts owed by debtors 14. The term “debt collector” as used herein is intended to refer to each and any of a non-lawyer collection service, a collection service having lawyers on staff, a collection attorney(s), or jointly to a non-lawyer collection service contracting with a collection attorney(s).

The nature of the agreement between the debt collector 10 and the creditor 12 is an important feature of the present invention. The typical agreement will provide for payment of a fixed fee by the creditor 12 to the debt collector 10 for a particular collection. (Discount pricing can be available for multiple collections.) The pricing will depend on the jurisdictional limit of the court in which suit would be filed and the services to be performed by the debt collector 10.

Thus, most jurisdictions have courts of limited jurisdiction, variously known as “Justice Courts” or “Municipal Courts.” Such courts have jurisdiction over claims below a certain amount. They generally provide streamlined dispute resolution procedures, and provide a non-jury trial within a relatively short period of time. The trial itself is generally short and informal, and non-lawyers typically represent themselves at such proceedings. For reasons of economy, discovery is generally not undertaken in cases pending before such courts. For the foregoing reasons, courts of limited jurisdiction such as Justice and Municipal Courts can provide an efficient and cost-effective forum for resolving many commercial disputes.

In Arizona, the inventor's home state, for example, Justice Courts currently have jurisdiction over claims up to $10,000. The procedure for processing a claim in Justice Court in Arizona is straightforward—there is the filing and service of the complaint, the service of a disclosure statement on the opposing party, a pre-hearing conference at the Justice Court, and a trial.

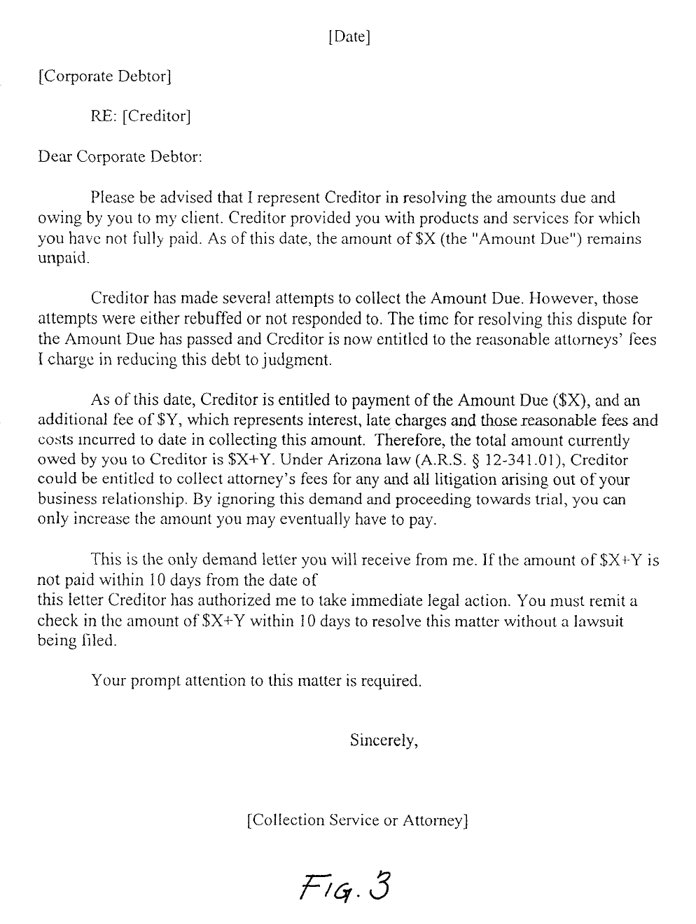

In the preferred embodiment, the debt collector 10 contracts with the creditor 12 to collect a debt from a debtor 14 in an amount that is within the jurisdictional limit of a Justice Court or the like having a streamlined dispute resolution process. The contract will obligate the creditor 12 to pay a fixed fee to the d e b t collector 10, in exchange for which the debt collector will provide certain specific services and, preferably, pay certain costs. For example, the contract can obligate the debt collector 1 to do all of the following: (a) prepare and send a demand letter to the debtor 14, preferably in the form illustrated in FIG. 3; (b) if necessary, prepare, file and serve a complaint against the debtor 14; (c) if necessary, prepare other documents and take other actions required by the court in which the suit is pending in order to prepare the case for trial (including, for example, the preparation of a disclosure statement and the conduct of a pre-hearing conference); and (d) if necessary, conduct the trial. For the same or an additional fee, the debt collector 10 can further agree to enforce a judgment obtained at trial, by, for example, paying for a garnishment, attending the actual collection with the sheriff, etc.

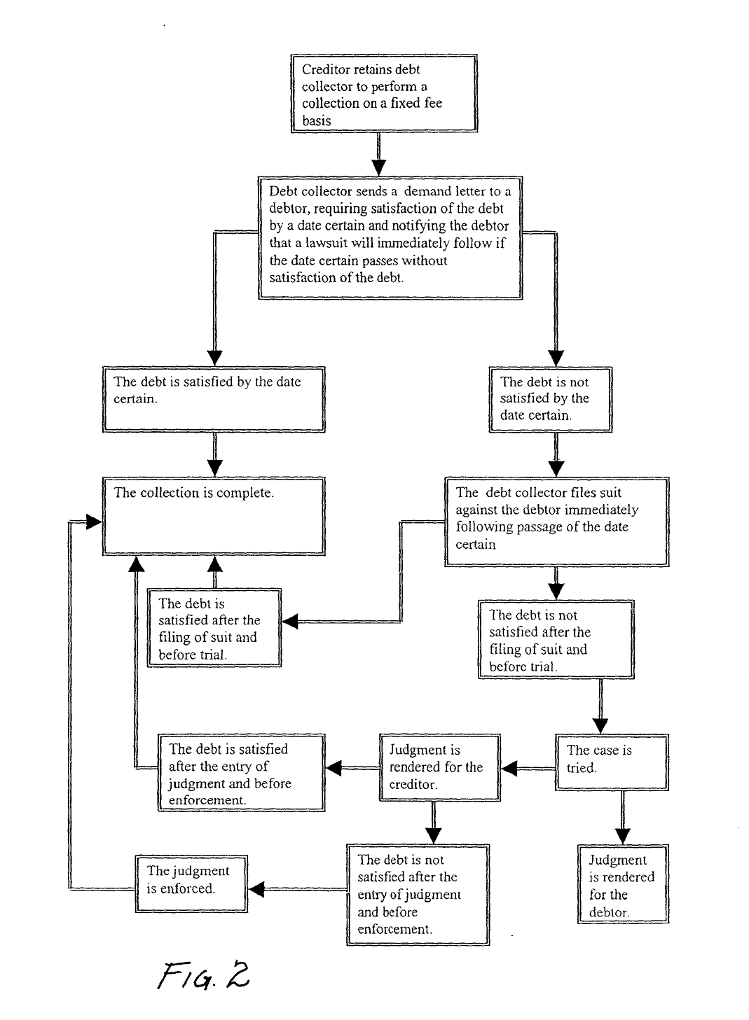

Referring now to FIG. 2, a flow chart showing the steps of the method of the present invention. The process begins with retention of the debt collector 10 by the creditor 12. As discussed above, the retention will typically require the creditor 12 to pay a fixed fee to the debt collector 10, regardless of the debt collector 10's success or failure in collecting the debt and regardless of the amount of the debt—provided that it is within the jurisdictional limit of a court of limited jurisdiction having relatively streamlined dispute resolution procedures such as a justice or municipal court. (It would be possible, of course, to provide a larger fixed fee for disputes that would be brought in courts with unlimited jurisdiction, although the unpredictability of the extent of effort potentially required to successfully collect on a debt in a court of unlimited jurisdiction makes this less attractive.)

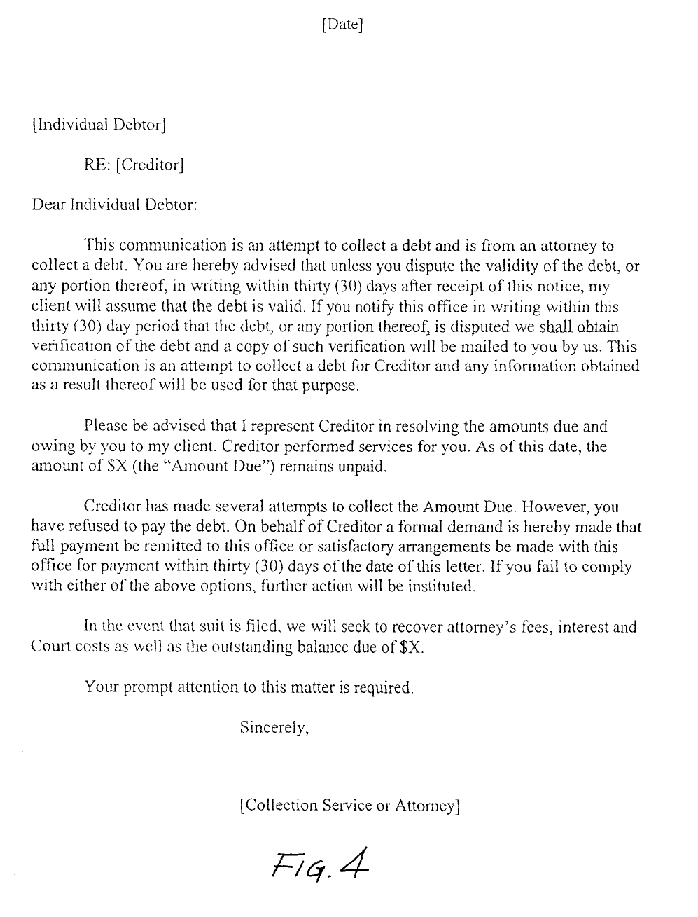

In the typical case, the debt collector 10's first action following retention will be to send a demand letter to the debtor 14. FIG. 3 provides an example of the text of a typical demand letter to a business, while FIG. 4 provides an example of the text of a typical demand letter to an individual. The demand letter will generally advise the debtor 14 that demand is made for payment of a particular debt owed to a particular creditor. The demand letter will provide the debtor 14 with a set amount of time, by the end of which the debt must either be paid or negotiated, failing which a lawsuit will immediately follow. The amount of time provided by the letter should preferably be about ten days, but where the debtor is an individual (see FIG. 4), there may be a legal requirement in certain jurisdictions to provide a thirty (30) day or other period of time in which to respond to the demand letter before suit can be filed.

The demand letter is sent by the debt collector 10. Where the debt collector 10 is a non-lawyer collection service contracting with a collection attorney(s), it is preferable to have the collection attorney(s) send the demand letter, so as to more concretely express to the debtor 14 the commitment of the creditor 12 to resort to legal means if necessary to collect the debt—and to illustrate the seriousness of the statement in the demand letter that a lawsuit will immediately follow the failure to satisfy the debt within the prescribed period.

In many cases, the demand letter will be sufficient to cause the debtor to satisfy the debt, by payment in full or at a negotiated amount. In such cases, the collection is complete and the process is at an end.

In other cases, the demand letter will not lead to satisfaction of the debt. Here, the next step is for suit to be filed against the debtor for collection of the debt, precisely as stated in the demand letter. This step will involve the preparation and filing of a complaint and its service on the debtor 14.

Again, in many cases, the filing of suit will be sufficient to cause the debtor to satisfy the debt, by payment in full or at a negotiated amount. In such cases, the collection is complete and the process is at an end.

In other cases, the filing of suit will not lead to satisfaction of the debt. Here, the next step is to prepare the case for trial and to try it. In Justice Court in Arizona for example, the preparation of a case for trial involves the preparation and service of a discovery disclosure statement, attendance at a pre-hearing conference with the defendant, and conduct of the trial itself.

In the event the trial ends in a judgment for the defendant, the collection is at an end. If the trial ends in a judgment for the creditor, the judgment itself may be sufficient to cause the debtor to pay the debt or reach an agreement to compromise the debt—again ending the collection. If the judgment is not sufficient to cause payment, it would then be necessary to enforce the judgment to obtain payment. Generally, because the enforcement step should only relatively rarely need to be resorted to, the initial pricing for the collection will not include enforcement as a service to be provided by the debt collector 10—although of course the agreement could so provide. Instead, in the typical case, the enforcement can be billed separately, and preferably also on a fixed fee basis.

Many of the steps shown in FIG. 1 can be automated for greater efficiency. For example, the debt collector 10 can generate form demand letters, complaints, and other documents required for a collection, which forms can be customized as needed for individual collections. Such form documents should, preferably, be stored electronically.

It would also be desirable to provide for electronic communication between the debt collector 10 and creditor 12, so that identifying information for debtors 14 can be efficiently provided to the debt collector 10—particularly where numerous debtors 14 are involved. Indeed, the greater the number of debtors 14, the more desirable it will be to automate the collection process, including providing software to track individual collections—including the identity of debtors, the status of the collection for each debtor, demand letter and court deadlines, and other relevant information and time issues. Access to information about the collection process can also be made available by the debt collector 10 to the creditor 12.

While the invention has been particularly shown and described with reference to preferred embodiments thereof, it will be understood by those skilled in the art that the foregoing and other changes in form and details may be made therein without departing from the spirit and scope of the invention.

We claim:

1. A method for collecting a debt comprising the steps of:
retaining a debt collector to collect a debt owed by a debtor to a creditor;
said debt collector agreeing to take steps to attempt to collect said debt from said debtor in exchange for a fixed fee payment from said creditor;
wherein payment of said fixed fee payment is independent of whether said debt collector is successful in collecting said debt from said debtor; and
said debt collector attempting to collect said debt from said debtor.

2. The method of claim 1 wherein said steps include the sending of a demand letter to said debtor.

3. The method of claim 2 wherein said steps include the filing of a lawsuit against said debtor to collect said debt.

4. The method of claim 3 wherein said steps include the conduct of pre-trial activities in support of said lawsuit.

5. The method of claim 4 wherein said steps include the conduct of a trial in support of said lawsuit.

6. The method of claim 5 wherein said steps include the enforcement of a judgment obtained as a result of said lawsuit.

7. The method of claim 2 further comprising the step of sending said demand letter to said debtor.

8. The method of claim 7 wherein said demand letter informs said debtor that said lawsuit will be filed if said debt is not paid within a specified period of time.

9. The method of claim 8 further comprising the step of filing said lawsuit against said debtor after expiration of said specified period of time.

10. The method of claim 3 further comprising the step of sending said demand letter to said debtor.

11. The method of claim 10 wherein said demand letter informs said debtor that said lawsuit will be filed if said debt is not paid within a specified period of time.

12. The method of claim 11 further comprising the step of filing said lawsuit against said debtor after expiration of said specified period of time.

13. The method of claim 4 further comprising the step of sending said demand letter to said debtor.

14. The method of claim 13 wherein said demand letter informs said debtor that said lawsuit will be filed if said debt is not paid within a specified period of time.

15. The method of claim 14 further comprising the step of filing said lawsuit against said debtor after expiration of said specified period of time.

16. The method of claim 15 further comprising the step of conducting said pre-trial activities in support of said lawsuit.

17. The method of claim 16 wherein said steps further include conduct of said trial and further comprising the step of conducting said trial.

18. The method of claim 17 wherein said steps further include enforcement of a judgment obtained following said trial and further comprising the step of enforcing said judgment.

19. A method for collecting a debt comprising the steps of:
retaining a debt collector to collect a debt owed by a debtor to a creditor;
said debt collector agreeing to take steps to attempt to collect said debt from said debtor in exchange for a fixed fee payment from said creditor;
wherein said steps include each of the sending of a demand letter to said debtor, the filing of a lawsuit against said debtor to collect said debt, the conduct of pre-trial activities in support of said lawsuit, and the conduct of a trial in support of said lawsuit;
wherein payment of said fixed fee payment is independent of whether said debt collector is successful in collecting said debt from said debtor; and
said debt collector attempting to collect said debt from said debtor by taking at least one of said steps.
